(19) United States
(12) Patent Application Publication
(10) Pub. No.: US 2001/0018857 A1
(43) Pub. Date: Sep. 6, 2001

(54) Digital forming and cutting unit with circular knives and a guillotine

(76) Inventor: Pierre-David Laroche, Ivry-sur-Seine (FR)

Correspondence Address: BLANK ROME COMISKY & MCCAULEY LLP, THE FARRAGUT BUILDING, SUITE 1000, 900 17th STREET, NW, WASHINGTON, DC, 20006, US

(21) Appl. No.: 09/741,141

(22) Filed: Dec. 21, 2000

(30) Foreign Application Priority Data
Dec. 23, 1999 (FR) 99 16388

(51) Int. Cl. B26D 1/14

(52) U.S. Cl. 83/564; 83/508.2

(57) ABSTRACT

The unit makes it possible to form and cut a sheet (14) made of flexible material, such as paper, cardboard or a plastic medium. It comprises several cutting boxes (2) each having a circular knife (5) and at least one guillotine (27). The cutting boxes (2) are fixed adjustably to a guide bar (3) extending transversely to the direction of movement of the sheet (14), and the circular knives (5) are removably fixed to the said cutting boxes. The forward movement of the sheet (14) and the movement of the guillotine or guillotines can be controlled numerically.

The present invention relates to a forming and trimming unit, that is to say for cutting or scoring or perforating or cutting half-way through sheets made of vegetable material, such as paper, cardboard, plastic media or the like.

Forming is intended to mean scoring, perforating or cutting half-way through the above sheets.

The invention more particularly relates to a cutting machine for cutting or scoring or perforating or cutting half-way through, from large-format sheets, pre-printed rectangular articles of various sizes, such as business or invitation cards, labels or the like.

Up to the present time the work of printing invitation or business cards, booklets or brochures was carried out by a printer, a professional specialising in the use of a cutting machine responsible for the cutting work.

Such printing and cutting work has a high cost price in the cases where small quantities of formed articles are produced, the setting of the machines (printer and cutter) often taking more time than the printing and cutting of the articles.

Such printing work is today carried out by means of a printer or photocopier. These tools make it possible to obtain good results at a lower cost.

However, there are no cutting machines easy to use and make it possible to rapidly and easily change the cutting dimensions and the parts of the said cutting machine.

The forming and trimming unit presented here provides a solution to this technical problem. This unit is easy to use, which enables it to be handled easily by nonprofessionals, who can thus quickly perform precise and neat cuts and forming.

Maintaining the cutting machines, up to the present time, was difficult and expensive. It required on the one hand mechanical aptitude for changing the parts and making the adjustments. Moreover, the bedknife formed by a roller was produced from a material softer than that employed for the blade of the knife, its change for reasons of wear giving rise to a high cost.

The present invention aims to afford a solution to these technical problems.

The invention thus relates to a shaping and cutting unit with circular knives and guillotine, for shaping and cutting a sheet made of flexible material, such as paper, cardboard or a plastic medium, comprising several cutting boxes each having a circular blade for cutting or forming the sheet continuously in a direction parallel to its direction of movement and at least one guillotine for cutting or forming the sheet in a direction transverse to its direction of movement, each circular blade being able to bear on the sheet in an area in which the latter is in abutment on a rotating roller whose axis is perpendicular to the direction of movement of the sheet according to the invention, this unit is characterised in that the cutting boxes are fixed adjustably to a guide bar extending transversely to the direction of movement of the sheet, and in that the circular blades are fixed removably to the said cutting boxes.

According to a preferred version of the invention, each guide bar carries several cutting boxes.

Preferably the shaping and cutting unit comprises several parallel guide bars spaced apart in the direction of movement of the sheet.

Preferably also, each cutting box is mounted on the guide bar so as to be able to be moved by rotation on this bar, between:

a working position in which the blade of the circular knife bears on the sheet to be formed or cut,

a position of inactivity in which the blade of the knife is not in contact with the sheet.

Other particularities and advantages of the invention will also emerge from the following description and an examination of the accompanying drawing, in which:

FIG. 1 depicts, in plan view, the cutting box of the cutting machine on a guide bar according to one embodiment of the invention;

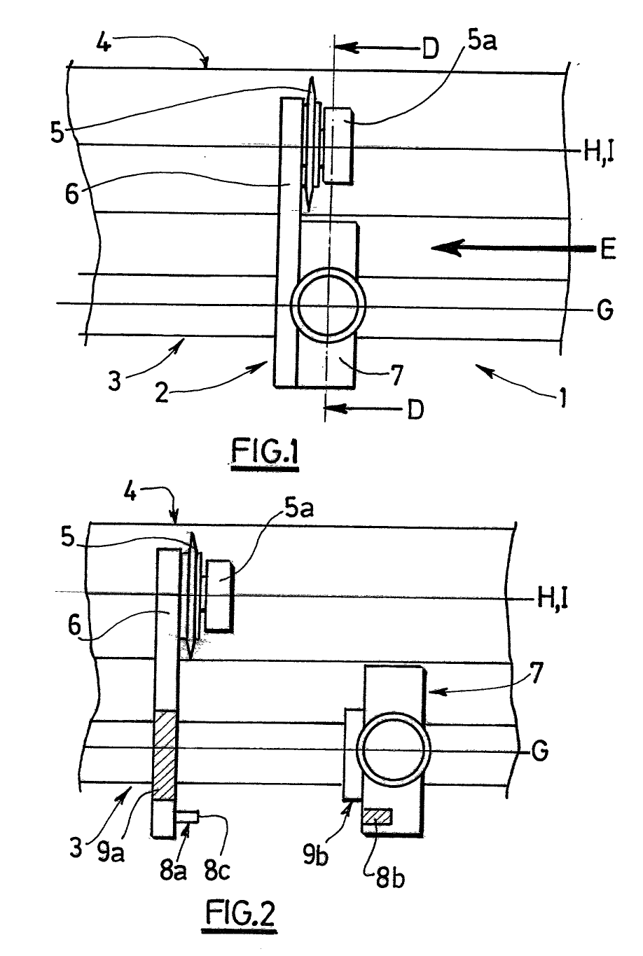

FIG. 2 depicts, in plan view, the cutting box of the cutting machine of FIG. 1 with the arm carrying the knife separated from the movement device;

FIG. 3 to 6 depicts the cutting box of FIG. 1 in partial transverse section D-D in the direction E;

FIG. 3 depicts the cutting box in the tool changing position;

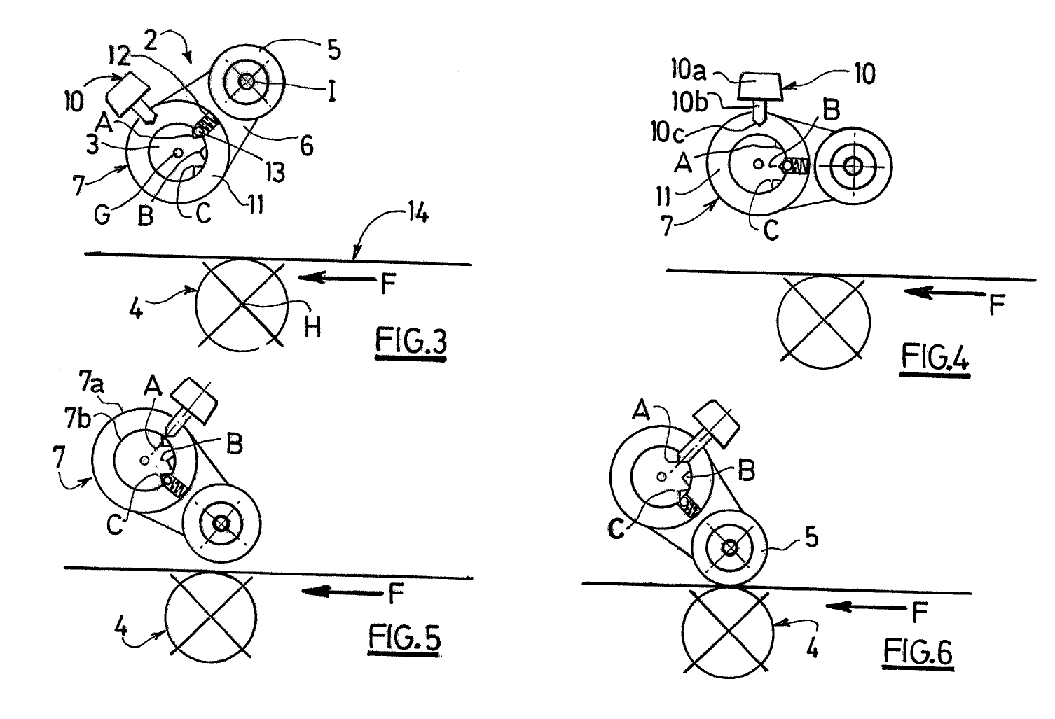

FIG. 4 depicts the cutting box in the idle position;

FIG. 5 depicts the cutting box in the damped position;

FIG. 6 depicts the cutting box in the working position;

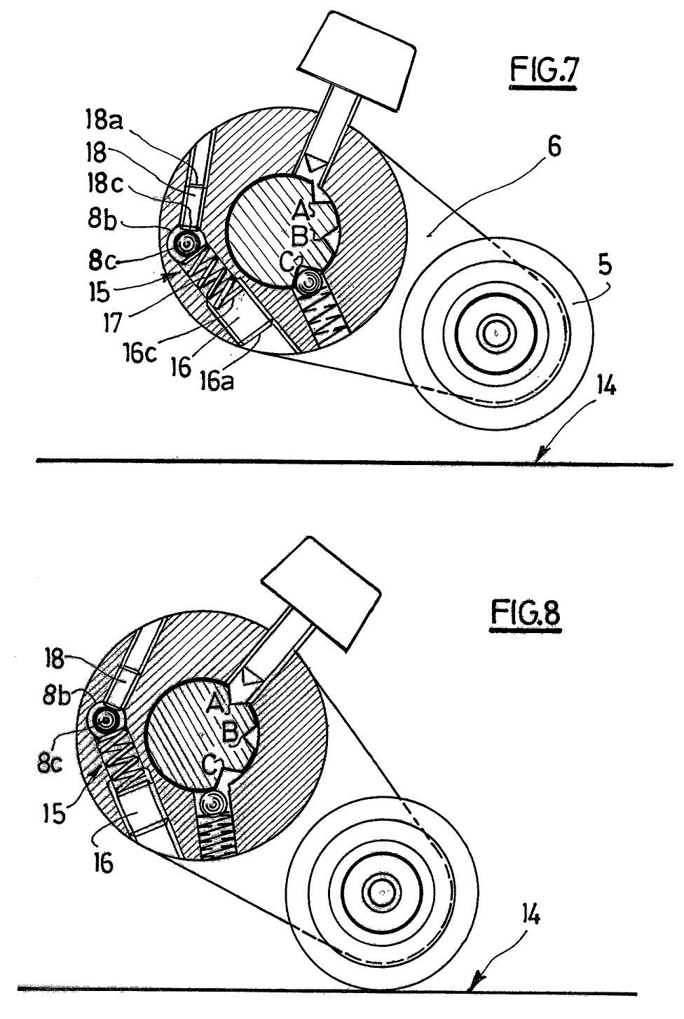

FIG. 7 depicts a preferred embodiment of the cutting box in the damped position in transverse section;

FIG. 8 depicts the cutting box of FIG. 7 in the working position;

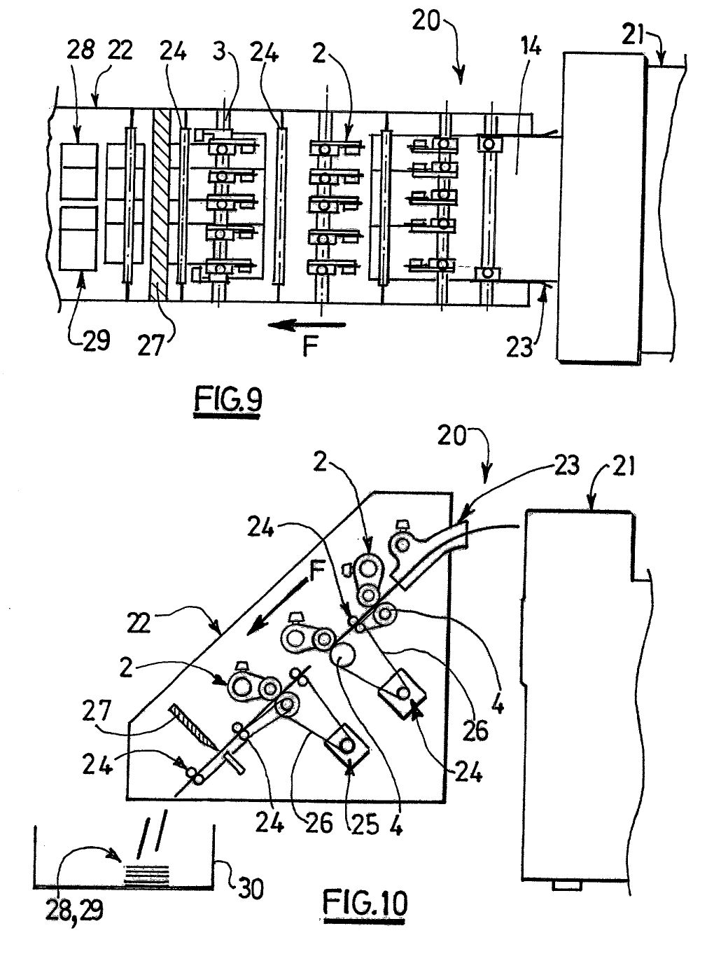

FIG. 9 depicts a cutting machine in plan view;

FIG. 10 depicts the cutting machine of FIG. 9 in transverse section.

Referring to FIG. 1, the forming and cutting unit comprises a cutting box 2, a guide bar 3 and a bedknife 4.

The guide bar 3 is fixed. It carries the cutting box 2 and acts in the guidance and movement of the said cutting box.

The guide bar 3 comprises at least one groove which acts during the locking of the cutting box 2 against the sheet of vegetable material and the bedknife 4.

The bedknife 4 can be a continuous roller. The external surface of the bedknife is metallic.

The axis G of the guide bar 3 is parallel to the axis of rotation H of the roller 4.

A cutting box 2 comprises a knife 5, an arm 6 and a device for moving the cutting box 7.

The knife 5 of the cutting box is circular and can be separated from the arm. To this end, it suffices to remove the knob Sa from the end of a shaft carrying the knife 5. It is in rotation about the axis I. The knife 5 has a metallic blade whose hardness is less than the hardness of the metal making up the external surface of the bedknife 4.

The function of the arm 6 is to carry the knife 5 and allow movement of the knife by the user without danger.

The movement device 7 acts during the movement of the cutting box 2.

The movement of the cutting box 2 can take place along the guide bar 3 and/or by rotation above the axis G of the said guide bar.

The device 7 for moving the cutting box 2 is in the form of a washer in rotation about the guide bar along the axis G. A movement device or washer 7 will be spoken of hereinafter.

The washer 7 and the arm 6 of the cutting box 2 are connected by mutual nesting. This is because the arm 6 has an appendage 8a which is housed in a housing 8b and the washer 7 adapted to its size and a protuberance 9b on the washer extending around the guide bar 3 is housed in an appropriate space 9a in the arm 6.

In the light of FIGS. 3 to 6, the movement device 7 comprises a locking/unlocking means 10 and a device 11 for stabilising the cutting box 2 in a certain number of positions around the guide bar 3.

The stabilisation device 11 for the cutting box 2 is a subassembly in a single piece consisting of a screw with pusher and spring. It comprises a spring 12 and a ball 13 both housed in a cavity in the form of a tube closed at one of its ends. The second end of the tube is open and is in direct contact with the external surface of the guide bar 3.

The locking/unlocking means 10 makes it possible to lock the movement device 7 and therefore the cutting box 2 in a given position along the guide bar 3 and/or in a given position around the said guide bar.

The locking/unlocking means 10 can be a screw referred as a locking/unlocking screw 10. This locking/unlocking screw comprises a screw head 10a, a body 10b and an end 10c or screw point, opposite to the head 10a of the screw.

The head 10a of the locking/unlocking screw is situated outside the movement device 7 and is of easy access for the user.

The body 10b of the screw is partially housed in a tube-shaped cavity, one of whose orifices is situated at the external lateral surface 7a of the washer 7 and whose other end is situated level with the internal lateral surface 7b of the washer 7 in direct contact with the external surface of the guide bar 3.

The point 10c of the locking/unlocking screw 10 has a shape complementary to the shape of the hollow of at least one of the grooves of the guide bar 3 so as to be able to be housed in the said hollow.

The length of the groove depends on the mobility which it is wished to give to the cutting box 2 along the guide bar 3.

The guide bar 3 can comprise two other grooves acting during the stabilisation of the cutting box 2 in a given position about the guide bar 3.

According to FIGS. 3 to 6, the cutting box 2 can take three stable positions around the guide bar 3, which are called:

the tool change position (FIG. 3);

the idle position (FIG. 4)

the damping position (FIG. 5).

The working position (FIG. 6) is an unstable position.

When the cutting box 2 is made to pivot about the axis G in the clockwise direction starting from its idle position (FIG. 3), the ball is situated successively opposite the groove A, B and then C.

The three grooves A, B and C are situated at the same distance from each other.

FIG. 3 depicts the cutting box 2 in its tool change position. In this position, the ball 13 of the stabilisation device 11 for the cutting box 2 is housed in the groove A in the guide bar 3.

FIG. 4 depicts the cutting box 2 in its idle position.

In its position, the ball 13 is housed in the groove B.

FIG. 5 depicts the cutting box 2 in its damping position. In this position, the ball 13 is housed in the groove C.

The passage into one or other of the positions described above takes place by rotation of the cutting box 2 around the guide bar 3 in the clockwise direction or in the anti-clockwise direction depending on the starting position and the required arrival position.

During the transition path situated between two successive stable positions, the ball 13, driven by the rotation movement exerted by the user on the movement device 7, rolls over the external surface of the guide bar 3. The spring 12 is then compressed.

The exit of the cutting box 2 from a stable position results in the exit of one of the balls 13 from one of the grooves and the compression of the spring 12.

The entry of the cutting box 2 into a stable position results in the entry of the ball 3 into one of the grooves and the decompression of the spring 12.

The working position (FIG. 6) is an unstable position in the sense that the ball 13 is not housed in a groove.

When passing from the damping position (FIG. 5) to the working position (FIG. 6), the user exerts a rotation of the cutting box 2 by pushing for example the head 10a of the locking/unlocking screw 10 in the clockwise direction.

The washer 7 performs a slight rotation about its axis of rotation G, which is also the axis of the guide bar 3, and the blade of the knife 5 comes into contact with the sheet 14 to be formed, which moves in the direction indicated by the arrow F.

Inside the washer 7, under the action of the slight rotation exerted by the user as described above, the ball 13 leaves the groove C substantially. The said ball is driven in the clockwise direction.

The working position (FIG. 6) is unstable in the sense that, under the effect of the least impact between the blade of the knife 5 or the cutting box 2, for example, the ball 13 can once again enter the groove C and thus pass from the working position (FIG. 6) to the damping position (FIG. 5).

The working position (FIG. 6) must therefore be locked in order to force the cutting box 2 to remain in the working position (FIG. 6).

For this purpose, a locking means 10 is used, which may for example be a locking/unlocking screw. The screw 10 is screwed and the tip 10C of the said screw is housed in the groove A which, in the working position (FIG. 6), is situated opposite the tip 10C of the locking/unlocking screw 10. In the damping position (FIG. 5) this same screw tip 10C is slightly offset with respect to the groove A.

According to a variant of the invention depicted in FIGS. 7 and 8, the cutting box 2 can have a positioning device 15 for the arm 6 making it possible to adapt the position of the arm 6 according to the work required: scoring of the paper, cutting, perforation, cutting half-way through the paper amongst other things, and the type of paper: fine or thick for example.

Scoring work will require pressure of the knife 5 on the paper which is less than in the case of cutting work.

The cutting of a thick paper of the board type will require a pressure of the knife 5 on the paper which is greater than in the case of a paper of low weight.

The pressure device 15 of the cutting block 2 is situated in the washer 7 of the cutting box 2.

The pressure device 15 is composed of a pressure screw 16, a spring 17 and a positioning screw 18 as well as the appendage 8A of the arm 6 housed in the housing 8B of the washer 7.

The housing of the positioning screw 18 has two orifices. One of these opens to the outside, whilst the second orifice opens onto the housing 8B of the appendage 8A of the arm 6.

The pressure screw 16 and the spring 17 of the pressure device 15 are housed in a housing having two orifices. One of these orifices opens towards the outside of the washer 7, whilst the second orifice opens onto the housing 8B of the appendage 8A of the arm 6.

The pressure screw 16 is fixed to the spring 17 or pressure device 15. The spring 17 has one of its ends in contact with the head 8C of the appendage 8A of the arm 6, whilst the other end is in contact with the tip 16C of the pressure screw 16.

The heads 16A and 18A of the pressure screw 16 and positioning screw 18 are accessible to the user at the orifices of their respective housing opening onto the outside of the washer 7.

When the positioning screw 18 is screwed in, the tip 18C of the said positioning screw 18 will push the head 8C of the appendage 8A of the arm 6 against the spring 17.

Thus, when the cutting box 2 passes from its damping position (FIG. 7) to its working position (FIG. 8), the slight movement due to the rotation exerted on the cutting box 2 will cause a contraction of the spring 17 of the pressure device 15, the said spring coming into abutment against the head 8C of the appendage 8A of the arm 6.

Depending on whether the positioning screw 18 is more or less screwed in, the head 8C of the appendage 8A of the arm 6 of the cutting box 2 is more or less pushed towards the spring 17 and the said spring is more or less compressed when the cutting box 2 passes from its damping position (FIG. 7) to its working position (FIG. 8).

Depending on whether the pressure screw 16 is more or less screwed in, the spring 17 is more or less pushed towards the head C of the appendage 8A of the arm 6 of the cutting box 2, and the spring 17 is therefore more or less compressed.

When the head 8C of the appendage 8A of the arm 6 is locked against the bottom wall of the housing 8B of the appendage 8A of the arm 6 at the level of the washer 7, the pressure of the knife 6 against the paper 14 is reinforced.

When the head 8C of the appendage 8A of the arm 6 is locked against the top wall of the housing 8B of the appendage 8A of the arm 6 at the level of the washer 7, the pressure of the knife 5 against the paper 14 is lessened.

When the spring 17 of the pressure device 15 is compressed, the pressure of the knife 5 against the blade 14 or bedknife 4 is greater.

FIGS. 9 and 10 depict a machine including a cutting unit 22, comprising guillotines as described above, placed at the exit of a printing unit or photocopier 21.

The paper 14 to be guillotined coming from the printing unit or photocopier 17 is guided into the cutting unit by means of guides 23. These guides 23 are positioned according to the width and position of the sheet 14 of paper to be guided.

The direction of movement of the paper is indicated by the arrow F.

The paper 14 is driven in the direction F by pairs of drive rollers 24 opposite each other, themselves driven by motors 25 via belts 26.

The paper 14 can be scored and/or cut, or perforated or cut half-way through continuously in the longitudinal direction of the sheet and then cut in the transverse direction by a guillotine cutter 27.

To this end, the unit according to the invention can include at least two guillotines, one being intended for cutting and the other for perforating or scoring or cutting half-way through.

It is thus possible to directly recover formed articles at the discharge from the cutting unit 22. These articles can be scored cards 28 and/or cards discontinuously 29.

This machine therefore has the advantage of being able to manufacture at the same time articles with different dimensions and shaping according to the adjustment of the positioning of the cutting box 2 on its guide bar 3 and according to the type of knife 5 used (scoring knife, discontinuous cutting knife and continuous cutting knife, for example).

The cards 28 or 29 are directly recovered in a receptacle 30 when they emerge.

The cutting machine according to the invention also has a knob for controlling the forward or backward movement of the sheet in order to bring it under the knives, which make it possible to obtain maximum precision in placing the knives on cutting lines.

The box carrying the knives also has a circlip which prevents the movement of the arm.

The main advantages of the invention are as follows:

less wear on the smooth-surfaced roller 4 because it is produced from a material more resistant to wear than the material constituting the blade of the knife 5;

easy and rapid replacement of the circular knife 5 by a new knife, a knife for scoring, grooving, perforating or cutting half-way through;

ease of adjustment of the position of the cutting box 2;

simultaneously cutting of cards 28 and 29 of different dimensions;

the possibility of simultaneously making cuts, grooves, perforations and cuts half-way through;

easy passage of the cutting box into the active or inactive position and visa versa.

The functioning of the forming and cutting unit according to the invention, in particular the movement of the sheet and that of the guillotine or guillotines, can be numerically controlled.

1. A forming and cutting unit with circular knives and a guillotine, for forming and cutting a sheet (14) made of flexible material, such as paper, cardboard or a plastic medium, comprising several cutting boxes (2) each having a circular knife (5) for cutting or forming the sheet (14) continuously in a direction parallel to its direction of movement, and at least one guillotine (27) for cutting or forming the sheet in a direction transverse to its direction of movement, each circular knife (5) being able to bear on the sheet (14) in an area where it is in abutment on a rotating roller whose axis is perpendicular to the direction of movement on the sheet (14), characterised in that the cutting boxes (2) are fixed adjustably to a guide bar (3) extending transversely to the direction of movement of the sheet (14), and in that the circular knives (5) are fixed removably to the said cutting boxes.

2. A forming and cutting unit according to claim 1, characterised in that each guide bar (3) carries several cutting boxes (2).

3. A forming and cutting unit according to one of claims 1 or 2, characterised in that it comprises several parallel guide bars (3) spaced apart in the direction of movement of the sheet.

4. A forming and cutting unit according to one of claims 1 to 3, characterised in that each cutting box (2) is mounted on the guide bar (3) so as to be able to be moved by rotation on this bar, between:
a working position in which the blade of the circular knife (5) bears on the sheet (14) to be formed or cut,
a position of inactivity in which the blade of the knife (5) is not in contact with the sheet (14).

5. A forming and cutting unit according to claim 4, characterised in that the cutting box (2) can take successively three positions of inactivity:
a tool change position appropriate for changing the knife (5) of the cutting box (2);
an idle position;
a damping position prior to a working position.

6. A forming and cutting unit according to any one of the preceding claims, characterised in that the guide bar (3) comprises at least one groove, enabling the cutting box (2) to be locked in a given angular position.

7. A forming and cutting unit according to one of the preceding claims, characterised in that a device (7) for moving the cutting box (2) comprises a means (10) of locking the said box in a given angular position.

8. A forming and cutting unit according to one of the preceding claims, characterised in that the guide bar (3) comprises three grooves (A, B and C) and the movement device (7) comprises a stabilisation device (11), the said stabilisation device comprising a spring (12) and a ball (13), which ball is housed successively in one of the three grooves (A, B or C) when the user causes the cutting box (2) to pivot into one of the positions of inactivity, the spring (12) compressing when the ball (13) leaves a groove and expanding when the ball (13) enters a groove.

9. A forming and cutting unit according to one of the preceding claims, characterised in that it comprises at least two guillotines, one being intended for cutting and the other for perforation, grooving or cutting half-way through.

10. A machine (20), characterised in that it comprises:
a forming and cutting unit according to any one of the preceding claims; and
a printing or photocopying unit (21).
